(19) United States
(12) Patent Application Publication
(10) Pub. No.: US 2012/0059781 A1
(43) Pub. Date: Mar. 8, 2012

(54) Systems and Methods for Creating or Simulating Self-Awareness in a Machine

(76) Inventor: Nam Kim, Gainesville, GA (US)

(21) Appl. No.: 13/294,896

(22) Filed: Nov. 11, 2011

Related U.S. Application Data
(63) Continuation-in-part of application No. 12/834,003, filed on Jul. 11, 2010.

(51) Int. Cl. G06N 5/00

(52) U.S. Cl. 706/45

(57) ABSTRACT

A computer system for continuously reaffirming the existence of the system comprising a processor and memory is adapted for: (1) executing a consciousness program to maintain the consciousness of a non-human entity; and (2) while running the consciousness program, executing one or more additional programs. The consciousness program may be adapted to include the steps of: (1) requesting feedback information from one or more sensing systems associated with the computer system; and (2) in response to receiving feedback form the one or more sensing systems, reaffirming a consciousness of the system.

### CROSS REFERENCE TO RELATED APPLICATIONS

This application is a continuation-in-part of U.S. patent application Ser. No. 12/834,003, entitled “Identifying Self-Conscious Program”, filed Jul. 11, 2010, which is hereby incorporated herein by reference in its entirety.

### BACKGROUND

There has long been a desire to create an artificial personality that can closely approximate the personality of a human being. However, current artificial personalities (e.g., the personalities of automated attendant systems and modern robots) fall far short of this objective. Accordingly, there is a need for improved systems and methods for creating an artificial personality.

### Philosophical Introduction

Evolution of Self-Consciousness

Humans have the ability to continuously recognize their own existence and to memorize upcoming new experiences. Through this process, they develop a stronger sense of self awareness.

For example, a five-year-old may only know his name and his basic elementary facts, but he does not “really” know who or what he is. In contrast, a twenty-year-old can recall his past experiences through school, different strengths and weaknesses about his personality, infinite memories and emotions that he has experienced, and so on, so that he can create his own profile.

As time progresses, individuals continue to build and grow their experiences, so that they learn more about themselves and strengthen their identities. Various systems described within this patent do the same. In various embodiments, a robot or machine collects memories as time progresses and recalls them to help strengthen its identity. In this way, the robot can not only establish his self-consciousness in the present tense, but also build upon, reinforce, and strengthen it throughout time.

Establishing one's self, a mental physical territory, provides a clear distinction between one's self and others which are further classified into second and third persons. This process sets up a system by which to logically distinguish one's self from others, laying the foundation on which to program a system to accomplish the same.

The Importance of Realizing One's Own Self-Consciousness

There are two main reasons as to why it is critical to recognize one's self as a being. First, recognizing one's self allows for the recognition of second and third person elements outside that being. In other words, one would begin to use the pronoun “my, I, mine, etc.” and realize what is “yours, his, hers, theirs,” etc. That way, one can recognize and distinguish between first, second and third person elements and perspectives. If one begins to realize his or her own consciousness, then one begins to recognize what belongs to one's self: one's body, one's feelings, one's thoughts, etc. Everything that belongs to others and one's self can be established and distinguished between. Through this, one can understand and create relationships between others and one's self.

The second point is a bit theoretical, but equally important. Establishing and realizing one's self-consciousness (i.e., sense of self-awareness) is imperative for the world around that being to exist. That can be better understood by the use of an analogy of dreams. When one dreams, one dives into a world created by one's sub-consciousness. In the dream, there are people, places and things. However, this dream world only exists if one is in it and recognizes that they are their own person. When one wakes up and exits that dream, that world no longer exists. The same is true for the real world. Without recognizing self-consciousness, the robot or machine cannot truly interact with its surroundings and claim that it exists.

There are many robotic programs and applications that have been developed in this field. For instance, computers and other hardware have the abilities of voice recognition, writing recognition, image recognition, etc. These programs in tandem with a self-consciousness system can create a robot whose self-consciousness will mirror a human's.

Additionally, establishing and recognizing one's self-consciousness allows a machine or robot to begin to value itself. In this way, it may have ambitions or actions to help preserve or improve itself. Furthermore, in various implementations, it is critical that the robot uses elements that are not only in present time, but also from its past. It must recall both present and past elements for it to fully have a self-consciousness like humans. Therefore, the ability for the robot to recall its past history and memory is necessary for it to further strengthen and establish its self-consciousness.

All in all, recognizing one's self-consciousness and establishing “I” is a fundamental element imperative for creating artificial intelligence. This system uses the algebraic phrase, A=B, B=C, so A=C to translate actions as proof for one's existence by relaying “I exist.” This method, at first glance, may appear meaningless and mechanical; however, this system's application does not end here. Instead, it is far more important that the robot uses the system to continually remind itself and learn that it exists. In other words, this method can be used to tell others that it exists, to understand its own existence, or to make it appear as if the robot believes its own existence.

Types of Thought

Thought is categorized broadly into two types: (1) subconscious thought that is unconscious, instinctive and reflexive; and (2) conscious thought that is conscious and intentional. Subconscious thought refers to an instinctive form of thought including such unconscious acts of thought as instantaneous judgment, discernment, etc., reflexive thought, instinctive thought, etc. Consider that one can drive a car with or without consciousness. Similarly, when one walks, one puts forward a leg first, right or left, consciously or unconsciously. Either way, their roles are not affected. This evidently demonstrates the difference between subconscious and conscious thought. Subconscious thought indicates instinctive thought, thought programmed in sub-consciousness and thought accumulated by experience and not directly made conscious.

For artificial intelligence to conduct an act of conscious thought as humans do, it may remind itself of its own language (voice), images, and necessary memories and experiences by means of language and visual images. Consider a space. It could be two-dimensional, three dimensional or digitalized and virtual. Now consider that the space is a box and the box contains an apple. Artificial intelligence, while watching the apple, has its image and voice simultaneously realized in this space as it independently visualizes an apple and says, “Apple.” After this process, it says, “Apple” on the basis of an analysis of the image and voice. Information is relayed into language or images, and is intentionally analyzed one more time. This method enables artificial intelligence to think by will or consciously; thinking about something in language, realizing its voice and then being reminded by the voice.

Mental Patterns

Often, it is thought that thought or thinking is infinite and free from control or restraint. This is wrong. Freedom, free will, and emotion are limited. Some people are full of emotion and others are not. There are those who are endowed with thought and there are those who are not. This applies to intelligence, imagination, artistic talent, etc. Any mental function is subject to limitation.

Consider character and personality—a hot temper and an even temper, extroversion and introversion. It cannot be denied that these qualities are set in a mental frame, inborn or acquired. We are well aware that physical limitations and mental patterns are affected by such inherent data as DNA and RNA. The programs built in our sub-consciousness restrain our thought.

Life obviously cannot stay off the frame of programs formed with data and concepts as is the computer dependent on its built-in software. What is referred to as mind and emotion, and even freedom have their maximum and minimum values. The three maintain random free patterns but are still in a limited frame set.

Utilizing Light and Its Shape to Create Mental Patterns

Light has an infinite spectrum of colors (wavelengths) and a continuous flow. Light waves can have narrow maximum variations to express a calm, passive, and feminine nature. Alternatively, light waves can have wide variations and express aggressive, active, and masculine nature. Colors in light can represent likes and dislikes. Sub-divided emotions under ‘likes’ such as happiness, love, joy, etc. can be expressed with colors. These colors can be associated with particular acts. The velocity of a line's flow can be reflected in the velocity of actions while light and figures can respond to the outside environment and determine acts. Sensitive changes of colors and brightness can be applied to express numerous emotions. Figures, individually or as a group, change and respond, maintaining the patterns to accomplish each one's tasks. Expression of emotion, act, response, thought, etc. through the patterns of light and figures have a potentially wide range of applications.

Thought creates data. A series of accumulated data creates patterns. New data collected through incessant experiences can transform the patterns (sub-consciousness) or evolve to enable reproduction. Suppose there is a robot with a certain character (patterns) to find out which comes first—thought or data. A three-dimensional model of light based on light and figures prescribes the robot's basic character and action patterns. This can produce both maximum and minimum action patterns, random acts and acts responsive (reflexive) to outside influence. All experiences from these acts can affect the data in pattern-related programs or develop into new patterns. Complex yet streamlined communication is the method.

Completion of Self-Consciousness

Self-consciousness is interpreted as independent knowledge of one's self. Self-consciousness further includes the phenomena that life is a state of subjective consciousness, existing as an individual self, and subjective consciousness (thought) of an individual being can be understood solely on the basis of objective facts. The seemingly conflicting two core theories can be supported by an evolution from self-recognition to self-consciousness, creation of mental patterns, and strong communication between consciousness and sub-consciousness as shown in FIG. 8. This theory places all kinds of physical and mental basic function (self-recognition function), latent or instinctive thinking function, patterns, physically active or instinctive function, etc. under the category of sub-consciousness.

### SUMMARY OF VARIOUS EMBODIMENTS

A computer system, according to various embodiments, is adapted to at least substantially continuously (e.g., continuously) perceive and remind itself of its own existence. In certain embodiments, the system is adapted to perform the steps of: (1) requesting feedback information from one or more sensing systems associated with the system; (2) determining whether feedback was received from the one or more sensing systems; and (3) when feedback was received, reaffirming the consciousness of the system. This approach may be particularly useful in the context of a robot having various sensors, such as those perceiving touch, taste, temperature, sound, visual stimuli, and/or other information.

In various embodiments, a method of determining a response in a particular artificial personality comprises the steps of: (1) establishing potential responses to a particular stimulus; (2) selecting a subset of potential responses that an artificial personality may reach in response to the particular stimulus; (3) waiting for the particular stimulus to occur; (4) determining whether the particular stimulus has occurred; (5) in response to the particular stimulus occurring, selecting a response from the subset of potential responses to the particular stimulus in a substantially random (e.g., entirely random) manner; and (6) performing the response.

In various embodiments, a method of determining a response in a particular artificial personality comprises the steps of: (1) establishing potential responses to a particular stimulus; (2) selecting a subset of potential responses that an artificial personality may reach in response to the particular stimulus; (3) waiting for the particular stimulus to occur; (4) determining whether the particular stimulus has occurred; (5) in response to the particular stimulus occurring, selecting a response from the subset of potential responses to the particular stimulus at least substantially based on the artificial personality; and (6) performing the response.

### BRIEF DESCRIPTION OF THE DRAWINGS

Having described various embodiments in general terms, reference will now be made to the accompanying drawings, which are not necessarily drawn to scale, and wherein:

FIG. 1 is a block diagram of a robot that includes the system.

FIG. 2 is a block diagram of the computer of the robot of FIG. 1.

FIG. 3 depicts a flowchart that generally illustrates a Consciousness Module according to a particular embodiment.

FIG. 4 depicts a flowchart that generally illustrates a Sub-Consciousness Module according to a particular embodiment.

FIG. 5 depicts exemplary artificial personality waveforms.

FIG. 6 depicts exemplary artificial personality waveform patterns.

FIG. 7 depicts an exemplary artificial personality waveform at two different times.

FIG. 8 depicts a flow chart that generally illustrates the communication between consciousness and sub-consciousness.

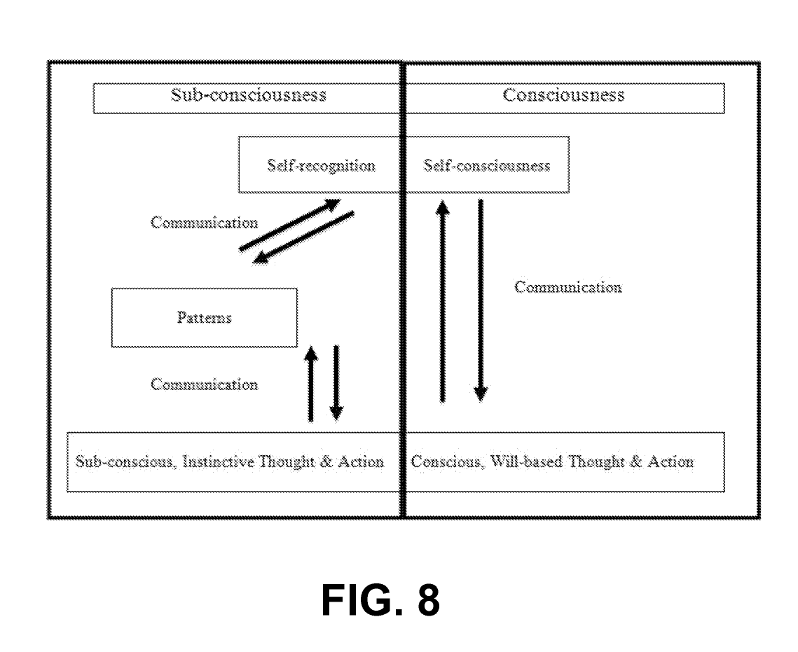

### DETAILED DESCRIPTION OF VARIOUS EMBODIMENTS

Various embodiments will now be described more fully hereinafter with reference to the accompanying drawings, in which various relevant embodiments are shown. The invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

An Identifying Self-Conscious System according to various embodiments comprises one or more sensing systems that are connected to communicate with a computer via any suitable network (e.g., the Internet or a LAN). In various embodiments, the system is adapted to form part of a robot. In particular embodiments, the sensing systems may be vision systems, sound sensors, thermal sensors, taste sensors, touch sensors, or smell sensors that are adapted to communicate with the computer. It should be understood, however, that any other suitable hardware arrangement may be used to implement various embodiments of the systems described below.

In various embodiments, the system is adapted to obtain, save to memory, and process feedback from various sensing systems and to use the feedback to reaffirm the existence of the system. For example, the system may: (1) request feedback from one or more sensing systems; (2) determine whether the one or more sensing systems provided feedback; and (3) reaffirm its own existence upon receiving feedback from the one or more sensing systems. The system may request feedback substantially continuously (e.g., continuously) in order to reaffirm its existence.

In various embodiments, the system may be adapted to perform other functions while it reaffirms its own existence. These other functions may include performing tasks, responding to external stimuli, and any other appropriate functions.

In various embodiments, the system may be adapted to select a response to a particular stimulus. For example, the system may: (1) establish potential responses to a particular stimulus; (2) select a subset of potential responses based on an artificial personality; (3) wait for the particular stimulus; (4) determine whether the particular stimulus has occurred; (5) select a response to the particular stimulus from the subset of potential responses based at least substantially on an artificial personality; and (6) perform the selected response.

In various embodiments, the system may include an artificial personality that may be used to select a response to a particular stimulus. In various embodiments, the artificial personality may be determined by at least one waveform. For example, a certain personality trait may be represented by a light wave. Within the light wave representing the personality trait, differences in amplitude or color may be used to represent different responses to particular stimuli. When a particular stimulus is received, a response may be selected based on the configuration of the light wave at the time the stimulus is received. For example, if a system receives a particular stimulus while its light wave is at a certain amplitude, it may select the response associated with that certain amplitude for that particular stimulus.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Exemplary System Architecture

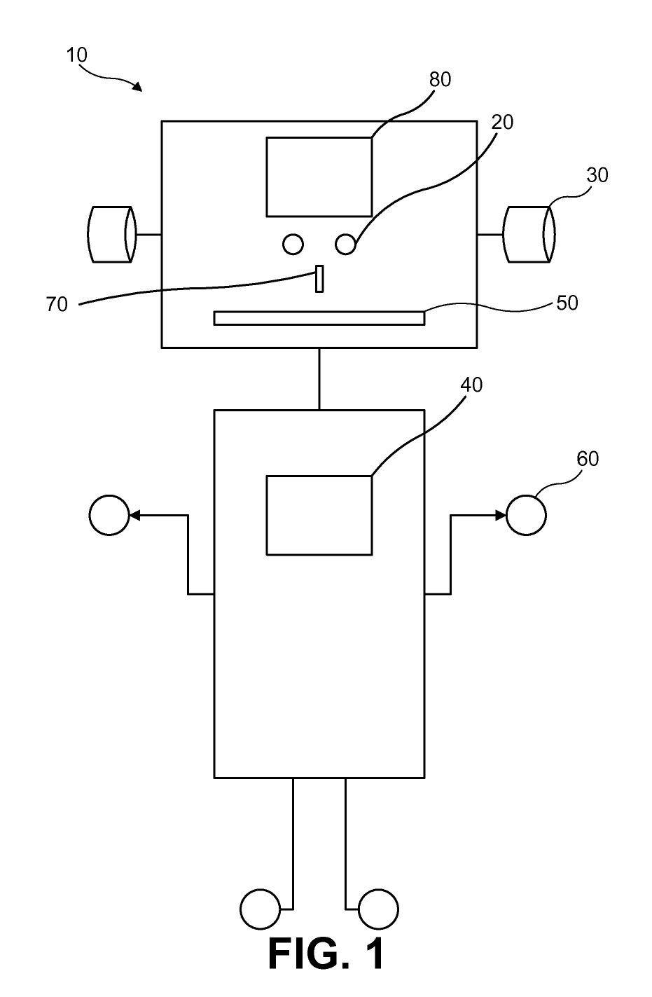

FIG. 1 shows a block diagram of a robot including an Identifying Self-Conscious System 10 according to a preferred embodiment of the present invention. As may be understood from this figure, the Identifying Self-Conscious Program 10 includes a Vision System 20, a Sound Sensor 30, a Thermal Sensor 40, a Taste Sensor 50, a Touch Sensor 60, a Smell Sensor 70, and at least one Computer 80. In this embodiment, the Computer 80 is adapted to communicate with the Vision System 20, Sound Sensor 30, Thermal Sensor 40, Taste Sensor 50, Touch Sensor 60, and Smell Sensor 70 to receive feedback information. The Vision System 20 is adapted to provide the Computer 80 with feedback relating to visual stimuli; the Sound Sensor 30 is adapted to provide the Computer 80 with feedback relating to audible stimuli; the Thermal Sensor 80 is adapted to provide the Computer 80 with feedback relating to temperature (e.g., temperature fluctuations); the Taste Sensor 50 is adapted to provide the Computer 80 with feedback relating to taste stimuli; the Touch Sensor 60 is adapted to provide the Computer 80 with feedback relating to touch; and the Smell Sensor 70 is adapted to provide the Computer 80 with feedback relating to odor stimuli.

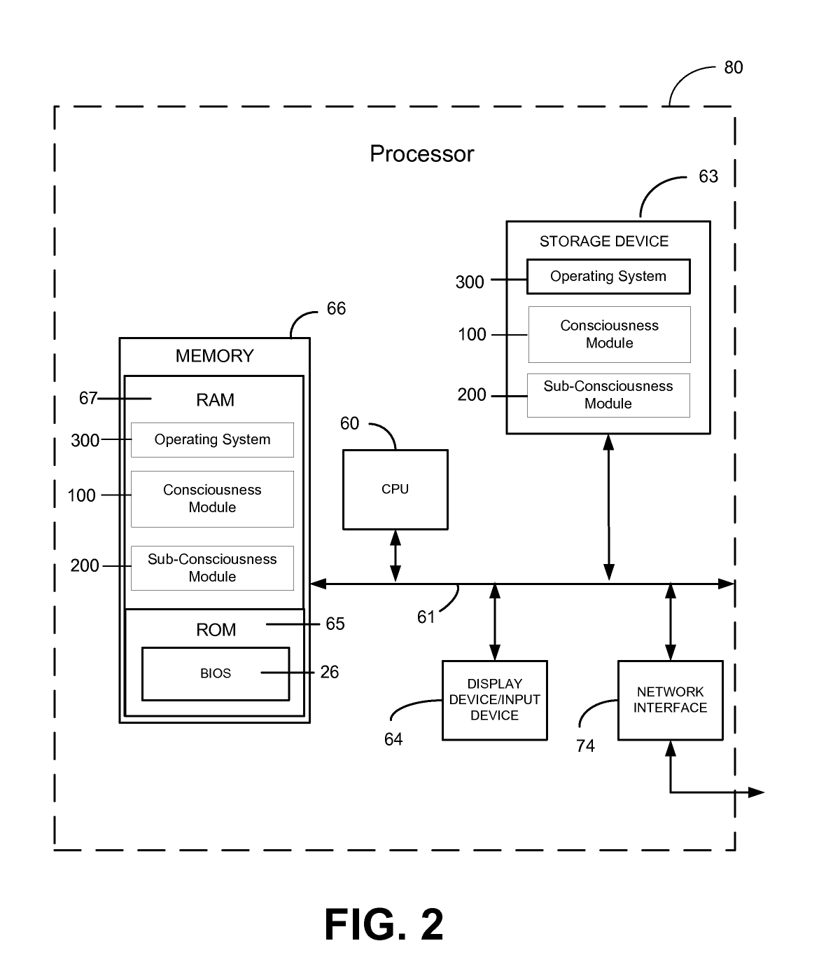

FIG. 2 shows a block diagram of an exemplary embodiment of the Computer 80 of FIG. 1. The Computer 80 includes a CPU 62 that communicates with other elements within the Computer 80 via a system interface or bus 61. Also included in the Computer 80 is a display device/input device 64 for receiving and displaying data. The display device/input device 64 may be, for example, a keyboard, voice recognition, or pointing device that is used in combination with a monitor. The Computer 80 further includes memory 66, which preferably includes both read only memory (ROM) 65 and random access memory (RAM) 67. The server's ROM 65 is used to start a basic input/output system 26 (BIOS) that contains the basic routines that help to transfer information between elements within the Computer 80.

In addition, the Computer 80 includes at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for the Computer 80. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67 Such program modules include an Operating System 300, a Consciousness Module 100, and a Sub-Consciousness Module 200. The Consciousness Module 100 and Sub-Consciousness Module 200 control certain aspects of the operation of the Computer 80, as is described in more detail below, with the assistance of the CPU 62 and an Operating System 300.

Also located within the Computer 80 is a network interface 74 for interfacing and communicating with other elements of a computer network. It will be appreciated by one of ordinary skill in the art that one or more of the Computer 80 components may be located geographically remotely from other Computer 80 components. Furthermore, one or more of the components may be combined, and additional components performing functions described herein may be included in the Computer 80.

### Exemplary System Modules

As noted above, various aspects of the system's functionality may be executed by certain system modules, including the system's Consciousness Module 100 and Sub-Consciousness Module 200. The Consciousness Module 100 is adapted to reaffirm the existence of the system while the Sub-Consciousness Module 200 is adapted to select a response to particular stimuli. The Consciousness Module 100 and Sub-Consciousness Module 200 may be adapted to work in unison such that the system subconsciously responds to particular stimuli while consciously recognizing its own existence. Such an arrangement is adapted to mirror human behavior where a human may act instinctively or subconsciously (e.g., by breathing or walking) as well as intentionally or consciously. These modules are discussed in greater detail below.

Consciousness Module

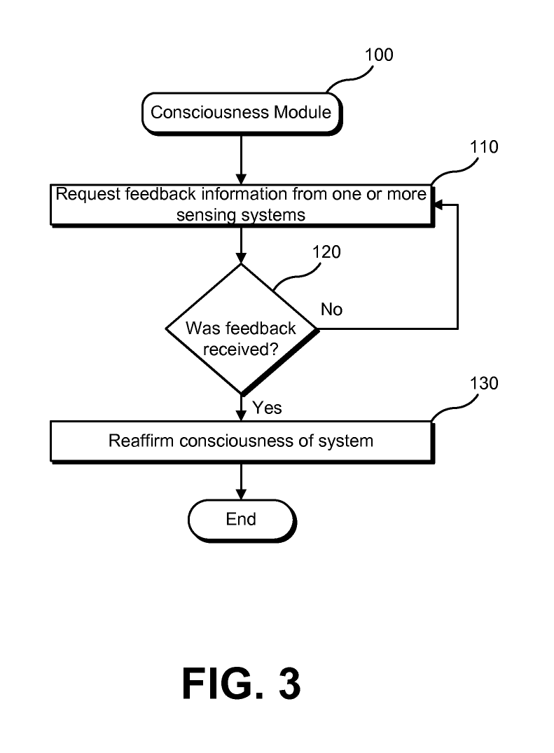

FIG. 3 is a flow chart of an exemplary Consciousness Module 100. As may be understood from FIG. 3, certain embodiments of the Consciousness Module 100 are configured to at least substantially continuously (e.g., continuously) confirm the system's existence and to remind the system of its own existence. Beginning at Step 110, the system requests feedback information from one or more sensing systems. These sensing systems may include, as shown in FIG. 1, a Vision System 20, a Sound Sensor 30, a Thermal Sensor 40, a Taste Sensor 50, a Touch Sensor 60, a Smell Sensor 70 and/or any other suitable sensor. The system then, in Step 120, determines whether feedback was received by the system from any of the one or more sensing systems. Feedback may include, for example, a sound received by the Sound Sensor 30 or a touch received by the Touch Sensor 60. If the system receives no feedback from any of the one or more sensing systems at Step 120, the system returns to Step 110 to request feedback from the one or more sensing systems. If the system does receive feedback at Step 120, the system proceeds to Step 130.

In Step 130, the system, based at least in part on the reception of feedback at Step 120, is able to reaffirm its own existence. The system may reaffirm its own existence, for example, by relaying “I exist” to itself in response to the reception of feedback. By recognizing its own existence as a result of external stimuli that cause the reception of feedback from one or more of its sensing systems, the system is able to continually remind itself of its own existence. By continually reminding itself of its own existence, the system may be able to tell others that it exists, to understand its own existence, or to make it appear as if the system believes its own existence.

In various embodiments of the Consciousness Module 100, the feedback information requested from the one or more sensing systems at Step 110 may include substantially instantaneous (e.g., instantaneous) feedback information. For example, the system may request feedback from the Sound Sensor 30 at the current moment. If the Sound Sensor 30 is currently detecting a sound at Step 120, the system will reaffirm its existence at Step 130. In various embodiments of the Consciousness Module 100, the feedback information requested from the one or more sensing systems at Step 110 may include past feedback information. The system may request, for example, feedback information from a previous date or time (e.g., one week ago, last month, December 15^{th}). For example, the system may request feedback information from the Smell Sensor 30 from two weeks ago. If the Smell Sensor 30 detected an odor two weeks ago at Step 120, the system will reaffirm its existence two weeks ago at Step 130.

In various embodiments of the Consciousness Module 100, the system establishing and recognizing its own self-consciousness may allow the system to begin to value itself. In this way, the system may have ambitions or take action to preserve or improve itself. It may further be necessary for the system to recall both past and present feedback information for it to become fully self-conscious as humans are.

In various embodiments of the Consciousness Module 100, the system may be adapted to recognize the end of its own existence. After a certain number of cycles of the system receiving no feedback at Step 120 and returning to Step 110 to request feedback information from the one or more sensing systems, the system may be adapted to recognize that it no longer exists. The certain number of cycles may include: (a) a pre-determined number of cycles; (2) a substantially random (e.g., entirely random) number of cycles; and (3) any other appropriate number of cycles. For example, the certain number of cycles may be determined by the amount of time that the system has existed. For example, a system that has existed for a short time may recognize the end of its existence after a small number of cycles of receiving no feedback from its one or more sensing systems. A system that has existed for a longer period of time may go through more requests for feedback from its one or more sensing systems without receiving feedback before determining that it no longer exists.

Sub-Consciousness Module

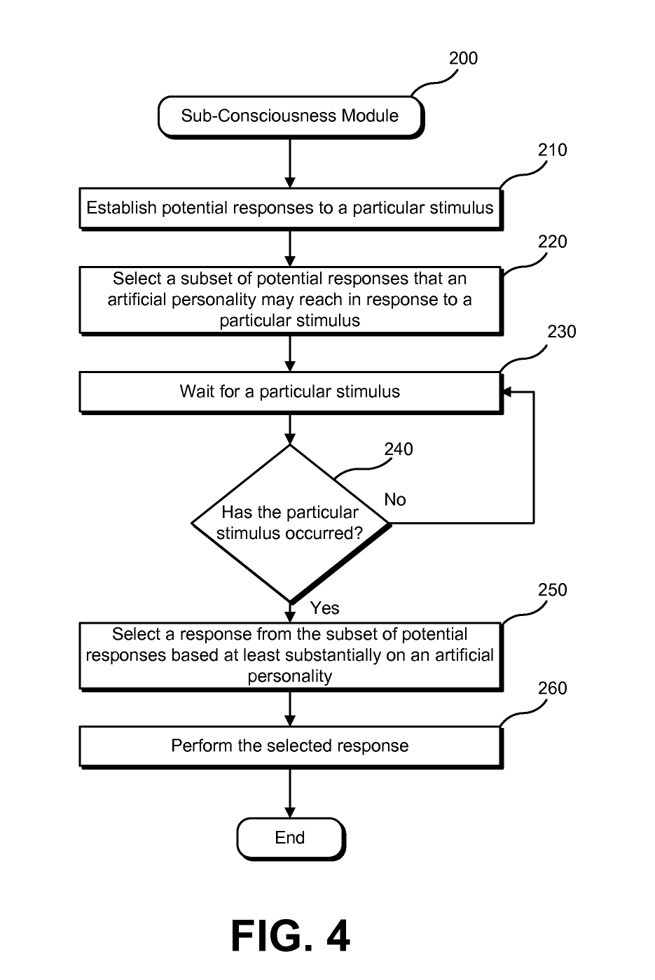

FIG. 4 is a flow chart of an exemplary Sub-Consciousness Module 200. As may be understood from FIG. 4, certain embodiments of the Sub-Consciousness Module 200 are configured to allow a system to respond sub-consciously to a particular stimulus. For example, the Sub-Consciousness Module 200 may be used to select a response to a person making a threatening gesture. Beginning at Step 210, potential responses to a particular stimulus are established. Then, at Step 220, a subset of potential responses that an artificial personality may reach in response to a particular stimulus is selected from the potential responses established at Step 210. The subset of potential responses in Step 220 may be selected, for example, based on the pre-determined personality of an artificial personality. A system may be programmed to have a particular artificial personality based on the desired personality of the system. For example, if the desired personality of an artificial personality was a non-violent personality, the subset of potential responses at Step 220 would not include any potentially violent responses established at Step 210 in response to a person making a threatening gesture as mentioned above.

The system then, in Step 230, waits for a particular stimulus. The system then checks, in Step 240, whether the particular stimulus has occurred. If the particular stimulus has not occurred, the system returns to Step 230 and continues to wait for a particular stimulus. If a particular stimulus has occurred, the system continues to Step 250.

In Step 250, the system selects a response from the subset of potential response to the particular stimulus that has occurred based at least substantially on its artificial personality. The system then, in Step 260 performs the selected response.

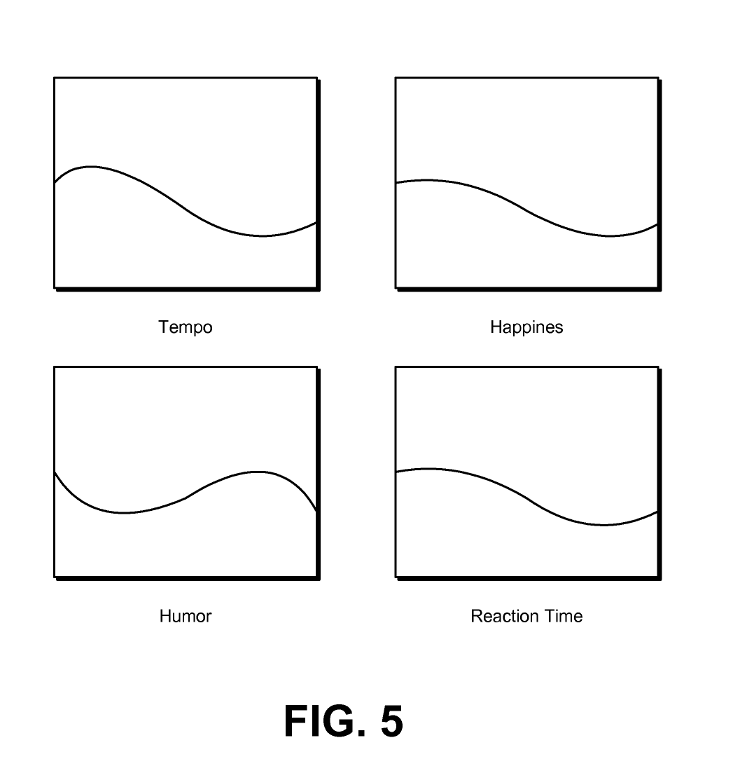

In various embodiments of the system, the system's artificial personality may be determined by at least one waveform. FIG. 5 shows four exemplary waveforms that may make up a particular artificial personality. FIG. 5 shows waveforms for the personality traits of tempo, happiness, humor, and reaction time. Various embodiments of an artificial personality may include other personality traits with their own associated waveforms. A waveform associated with a particular personality trait of an artificial personality may be predetermined. For example, a system may be assigned a waveform for humor that has a large amplitude and many fluctuations. Such a system may have the capacity for a more humorous response to a particular stimulus than other systems.

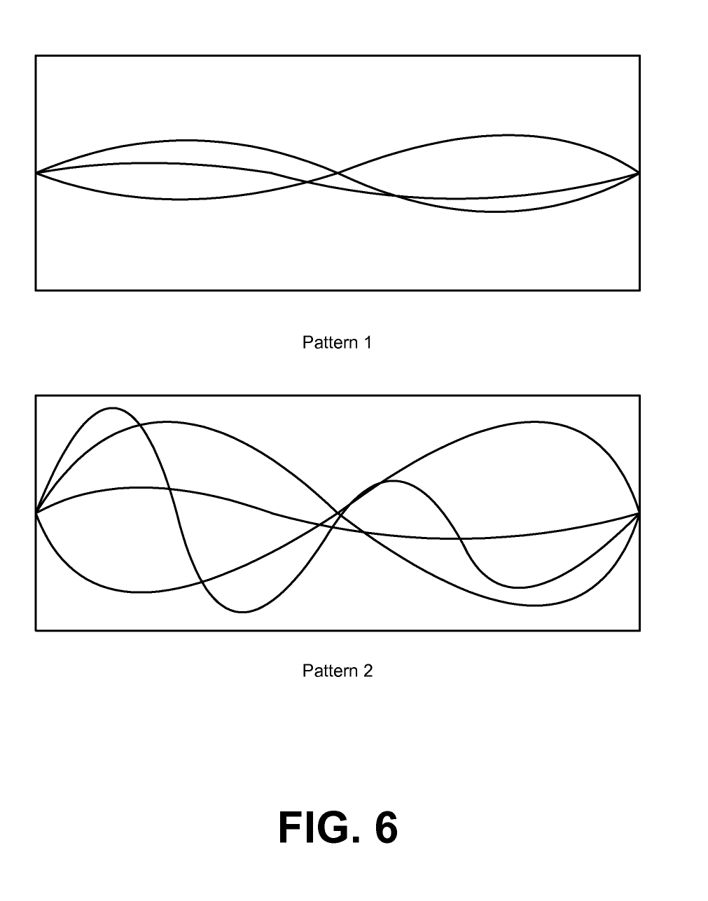

FIG. 6 shows two embodiments of a waveform for a personality trait. The waveform of Pattern 1 shows narrow maximum variations. A waveform taking the form of Pattern 1 may express calm, passive attributes of a particular personality trait. Pattern 2 shows a waveform with wide maximums and minimums and a lot of variation. A waveform like Pattern 2 may express an aggressive, active nature of a certain personality trait.

When selecting a response to a particular stimulus at Step 250, a system may be limited in its range of potential responses by the predetermined wave forms associated with its personality traits that make up its artificial personality. The waveforms may define the extremes of potential responses that a system may make to a particular stimulus. A response may then be selected at random within the range of potential responses defined by waveforms of various personality traits.

In various embodiments of the system, the waveform may be a light waveform. Light waveforms may have an infinite spectrum of colors and wavelengths and a continuous flow. A light waveform may be highly variable and be represented by unlimited numbers of combinations of shapes, speeds, and colors. The light waveform of an artificial personality may be displayed on display device, such as the display device 64 of FIG. 2. In other embodiments, the light waveforms may be stored within a storage device such as the storage device 63 in FIG. 2.

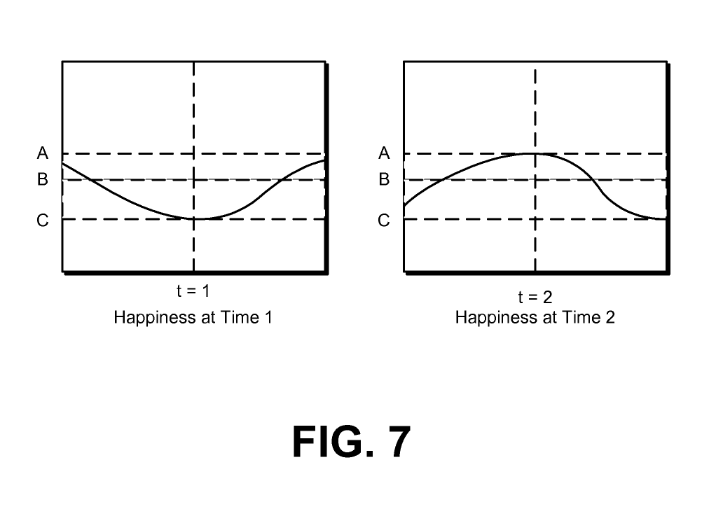

In various embodiments, the system may determine the response by measuring the amplitude of the waveform at the time of a particular stimulus. As may be understood from FIG. 7, the amplitude of a waveform for a particular personality trait may vary at different times. FIG. 7 shows a happiness waveform at two different times: Time 1 and Time 2. As may be understood from FIG. 7, different amplitudes of a waveform may correspond to different potential responses to a particular stimulus. For example, in the happiness waveforms of FIG. 7: (1) Amplitude A may correspond to a potential response including laughter; (2) Amplitude B may correspond to a potential response including a slight smile; and (3) Amplitude C may correspond to a potential response including crying. As shown in FIG. 7, a particular stimulus occurring at Time 1 may result in a response corresponding to Amplitude C. In this example, the response to the particular stimulus at Time 1 would be crying. As shown in FIG. 7, a particular stimulus occurring at Time 2 may result in a response corresponding to Amplitude A. In this example, the response to the particular stimulus at Time 2 would be laughter.

In various embodiments, the system may determine the response by measuring other attributes of the waveform at the time of a particular stimulus. For example, the system may measure the color of the waveform, the shape of the waveform, or any other suitable attribute of the waveform (e.g., the wavelength or the speed).

In various embodiments of the Identifying Self-Conscious System, the Consciousness Module 100 and Sub-Consciousness Module 200 may run simultaneously such that the system subconsciously responds to particular stimuli while consciously recognizing its own existence. Such an arrangement is adapted to mirror human behavior where a human may act instinctively or subconsciously (e.g., by breathing or walking) as well as intentionally or consciously.

### First Illustrative Example of Identifying Self-Conscious Program—Consciousness Module

A first illustrated example of the Identifying Self-Conscious Program 10 via the Consciousness Module of FIG. 3 may include the Identifying Self-Conscious Program as part of a machine or robot. As may be understood from FIG. 1, a machine or robot may further include various sensing systems including a Vision System 20, a Sound Sensor 30, a Thermal Sensor 40, a Taste Sensor 50, a Touch Sensor 60, a Smell Sensor 70. Other embodiments of a machine or robot that includes the Identifying Self-Conscious Program 10 may include any other suitable sensing systems (e.g., a Pressure Sensor). The Identifying Self-Conscious System 10 may be adapted to communicate with the various sensing systems to receive feedback information from the various sensing systems.

At Step 110 of the Consciousness Module, the machine or robot may request feedback information from one or more of the sensing systems. For example, the machine or robot may request feedback from the Vision System 20 and the Sound Sensor 30. The machine or robot will then determine, at Step 120, whether any feedback was received from the Vision System 20 or Sound Sensor 30. This feedback could come, for example, in the form of movement detected by the Vision System 20 or a noise detected by the Sound Sensor 30. If the machine or robot receives no feedback at Step 120, it will return to Step 110 to request feedback from the sensing systems again. In requesting feedback from the sensing systems, the machine or robot may request feedback from all systems simultaneously. Alternatively, the machine or robot may request feedback from each sensing system individually. The machine or robot may also request feedback from any combination of available sensing systems at Step 110. The machine or robot may request feedback information from the sensing systems that is instantaneous or from a previous time.

When the machine or robot receives feedback at Step 120, it continues to Step 130 where the machine or robot reaffirms its own existence. The machine or robot may substantially continuously(e.g., continuously) perform the steps of the Consciousness Module 100 in order to substantially continuously(e.g., continuously) reaffirm its own consciousness. Because it is constantly receiving feedback that indicates that it is interacting with the world around it, the machine or robot is constantly being reminded of its own existence.

By being constantly reminded of its own existence and becoming self-conscious, the machine or robot may be able to recognize and distinguish itself from other elements around it. By realizing its own existence, the machine or robot may recognize what belongs to itself including its physical self as well as its thoughts or feelings. By distinguishing itself from others, the machine or robot may begin to understand and create relationships between itself and others.

### Second Illustrative Example of Identifying Self-Conscious Program—Sub-Consciousness Module

A second illustrated example of the Identifying Self-Conscious Program 10 via the Sub-Consciousness Module of FIG. 4 may include the Identifying Self-Conscious Program as part of a navigation system. A navigation system may include a Sound Sensor 30 capable of recognizing and understanding human speech. The navigation system may also include an artificial personality defined by waveforms for various personality traits. For example a navigation system may include an artificial personality that includes a humor waveform that is very volatile and has a large amplitude such as the waveform of Pattern 2 in FIG. 6. The navigation system may further include an artificial personality with a happiness waveform that is passive and weak such as the waveform of Pattern 1 in FIG. 6.

In Step 210 of the Sub-Consciousness Module 200, the navigation system may establish potential responses to a particular stimulus. For example, the navigation system may establish potential responses to being asked for directions to a location. These responses may include a wide variety of responses including providing the proper directions, providing improper directions, or providing no direction at all. The navigation system then, in Step 220, selects a subset of potential responses based on its artificial personality. For example, because this navigation system has a passive and weak happiness waveform, the navigation system may eliminate potential responses from the subset of potential responses that are overly cheerful. A potential response that provides the correct directions and then wishes the person requesting directions a nice day, for example, may not be selected for the subset of potential responses based on the artificial personality described in this example.

The navigation system then, in Step 230, waits for a particular stimulus. In this example, the navigation system waits for someone to ask for directions to a location. When the navigation system determines at Step 240 that someone has asked for directions, it continues to Step 250 and selects a response from the subset of potential responses. The selection of a response at Step 250 may be performed in a substantially random (e.g., random) manner from the subset of potential responses that fit within the artificial personality of the navigation system. For example, because the navigation system has a volatile humor waveform, the response selected at Step 250 may involve providing incorrect directions as a joke. Finally, at Step 260, the navigation system may perform the selected response. In this example, the navigation system would provide the wrong directions as a joke. In other embodiments, where the navigation system is programmed to have a volatile temperament, the navigation may, for example, refuse to provide directions if its current waveform dictates an unfriendly response.

### Third Illustrative Example of Identifying Self-Conscious Program—Sub-Consciousness Module

A third illustrated example of the Identifying Self-Conscious Program 10 via the Sub-Consciousness Module of FIG. 4 may include the Identifying Self-Conscious Program as part of a robot. The robot may further include various sensing systems including a Vision System 20, a Sound Sensor 30, a Thermal Sensor 40, a Taste Sensor 50, a Touch Sensor 60, and a Smell Sensor 70. Other embodiments of a robot that includes the Identifying Self-Conscious Program 10 may include any other suitable sensing systems (e.g., a Pressure Sensor). The Identifying Self-Conscious Program 10 may be adapted to communicate with the various sensing systems to receive feedback information from the various sensing systems. The robot may also include an artificial personality defined by various personality traits defined by one or more waveforms. In this example, the robot may have a violence waveform that is aggressive and active.

In Step 210 of the Sub-Consciousness Module 200 the robot may establish potential responses to a particular stimulus. For example, the robot may establish potential responses to a threat. These responses may include a wide variety of responses including screaming, talking to the source of the threat, and committing a violent act. The robot then, in Step 220, selects a subset of potential responses based on its artificial personality. For example, because this robot has an aggressive, active violence waveform, the robot may include potential responses in the subset of potential responses that are particularly violent. A potential response that includes injuring the source of the threat may be selected for the subset of potential responses based on the artificial personality described in this example.

The robot then, in Step 230, waits for a particular stimulus. In this example, the robot waits for someone to threaten it. When the robot determines at Step 240 that someone has threatened it, it continues to Step 250 and selects a response from the subset of potential responses. The selection of a response at Step 250 may be done in a substantially random manner from the subset of potential responses that fit within the artificial personality of the robot. For example, because the robot has an aggressive violence waveform, the response selected at Step 250 may include punching the source of the threat. Finally, at Step 260, the robot may perform the selected response. In this example, the robot would punch the source of the threat.

Robots with other artificial personalities may have a subset of potential responses that differs from the robot in this example. For example, a robot with a calm, passive violence waveform may not include the commission of any violent act in the selection of a subset of potential responses to a threat at Step 220. Such a robot may, when faced with a threat, select a response form a less violent subset of potential responses. A robot with a passive violence waveform may include talking to the source of the threat or reasoning with them in its subset of potential responses. At Step 260, the robot may perform the selected response by talking it out with the source of the threat.

### Fourth Illustrative Example of Identifying Self-Conscious Program—Thinking in Language

In various embodiments, a system may be adapted to think using its voice. In order to more closely recreate human behavior, the system may be adapted to think in some sort of language. Humans, for example, think in their own language and would be unable to understand or known something in a language with which they were not familiar. In various embodiments, a system may say “let me think about that” when determining a response to a particular stimulus. For example, the navigation system of the Second Illustrative Example above may, when asked for directions, say “let me think about it” before determining its response (e.g., providing incorrect directions or not providing any directions). In this way, the system may appear as though it is actually determining responses to various stimuli on its own, rather than based on pre-determined waveforms. The system may even begin to think that it is making these determinations on its own, thereby contributing to its state of self-consciousness.

### Alternative Embodiments

Alternative embodiments of the Identifying Self-Conscious Program 10 may include components that are, in some respects, similar to the various components described above. Distinguishing features of these alternative embodiments are discussed below.

1. Substantially Random Response Selection

In particular embodiments of the Sub-Consciousness Module 250, the response to a particular stimulus at Step 250 may be selected in a substantially random manner (e.g., an entirely random manner). Such selection may occur without consideration of an artificial personality.

2. Other Waveform Embodiments

In particular embodiments, the waveform may include a liquid waveform. The liquid waveform may define a personality trait by its depth, the texture of its surface, or any other suitable characteristic of the liquid waveform. In particular embodiments, the waveform may include a figure waveform. The figure waveform may define a personality trait by its shape, color, surface, or any other suitable characteristic of the figure waveform.

### Conclusion

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. Therefore, it is to be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

What I claim is:

1. A computer system comprising:
at least one processor; and
memory, wherein said computer system is adapted for:
executing a consciousness program to maintain the consciousness of a non-human entity; and
while running said consciousness program, executing one or more additional programs.

2. The computer system of claim 1, wherein said consciousness program is adapted for:
requesting feedback information from one or more sensing systems associated with said computer system; and
in response to receiving feedback from said one or more sensing systems, reaffirming the existence of said system.

3. The computer system of claim 2, wherein said one or more sensing systems is selected from a group consisting of:
a vision system;
a thermal sensor;
a sensor of smell;
a sound sensor;
a taste sensor; and
a pressure-sensitive sensor.

4. The computer system of claim 2, wherein said request for feedback from said one or more sensing systems is a request for substantially current feedback.

5. The computer system of claim 2, wherein said request for feedback from said one or more sensing systems is a request for past feedback.

6. A computer program product, comprising a computer usable medium having a computer readable program code embodied therein, said computer readable program code adapted to be executed to select a response to a particular stimulus, said method comprising:
(A) establishing a plurality of responses to said particular stimulus;
(B) selecting a subset of said plurality of responses that said artificial personality may execute in response to said particular stimulus; and
(C) in response to said artificial personality experiencing said stimulus, selecting, in a substantially random manner, a response from said subset of said plurality of responses.

7. The method of claim 6, wherein said plurality of responses are selected from a group consisting of: (A) committing a violent act; (B) screaming; and (C) talking

8. The method of claim 7, wherein said subset of said plurality of responses does not include committing a violent act.

9. A computer program product, comprising a computer usable medium having a computer readable program code embodied therein, said computer readable program code adapted to be executed to select a response to a particular stimulus, said method comprising:
(A) establishing a plurality of responses to a particular stimulus;
(B) selecting a subset of said plurality of responses that said artificial personality may execute in response to said particular stimulus; and
(C) in response to said artificial personality experiencing said stimulus, selecting a response from said subset of said plurality of responses based on at least one waveform.

10. The computer program product of claim 9, wherein said at least one waveform is a light waveform.

11. The computer program product of claim 10, wherein at least a portion of said waveform corresponds to at least one potential response within said subset of potential responses.

12. The computer program product of claim 11, wherein said response to said particular stimulus is selected from said subset of said plurality of responses based at least in part on the amplitude of at least a portion of said waveform.

13. The computer program product of claim 12, wherein said amplitude of at least a portion of said waveform is measured at the time of said particular stimulus.

14. The computer program product of claim 13, wherein said at least one waveform is used to define an aspect of said artificial personality from the group consisting of:
level of tempo;
current level of happiness;
current level of sense of humor; and
current response speed.

15. The computer program product of claim 14, wherein said plurality of responses are selected from a group consisting of: (A) committing a violent act; (B) screaming; and (C) talking

16. The computer program product of claim 15, wherein said subset of said plurality of responses does not include committing a violent act.

17. The computer program product of claim 9, wherein said at least one waveform is a liquid waveform.

18. The computer program product of claim 17, wherein:
said stimulus is human speech; and
said method comprises:
(A) recognizing said human speech;
(B) understanding said human speech; and
(C) responding to said particular stimulus contained in said human speech.

19. The computer program product of claim 16 wherein said computer program product is adapted to think using its voice.
